(19) United States
(12) Patent Application Publication
(10) Pub. No.: US 2024/0348785 A1
(43) Pub. Date: Oct. 17, 2024

(54) METHODS AND DEVICES ON PROBABILITY CALCULATION FOR CONTEXT-BASED ADAPTIVE BINARY ARITHMETIC CODING

(71) Applicant: BEIJING DAJIA INTERNET INFORMATION TECHNOLOGY CO., LTD., Beijing (CN)

(72) Inventors: Xiaoyu XIU, San Diego, CA (US); Yi-Wen CHEN, San Diego, CA (US); Wei CHEN, San Diego, CA (US); Han GAO, San Diego, CA (US); Che-Wei KUO, San Diego, CA (US); Hong-Jheng JHU, San Diego, CA (US); Ning YAN, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 18/756,092

(22) Filed: Jun. 27, 2024

Related U.S. Application Data
(63) Continuation of application No. PCT/US2022/054291, filed on Dec. 29, 2022.

(51) Int. Cl. H04N 19/13; H04N 19/174; H04N 19/70

(52) U.S. Cl. CPC H04N 19/13; H04N 19/174; H04N 19/70

(57) ABSTRACT

Methods for video decoding and encoding, apparatuses and non-transitory computer-readable storage media thereof are provided. In one method for video decoding, a binary arithmetic decoder may obtain, according to an adaptive weight, a multi-hypothesis probability for a binary symbol of a context model for the binary arithmetic decoder, where the multi-hypothesis probability indicates a probability of the binary symbol equaling to a binary value, and the binary symbol is from a plurality of binary symbols associated with the context model. Furthermore, the decoder may decode the binary symbol according to the multi-hypothesis probability.

### CROSS-REFERENCE TO RELATED APPLICATIONS

The present application is a continuation of International Application No. PCT/US2022/054291, filed on Dec. 29, 2022, which claims priority to U.S. Provisional Application No. 63/294,692, entitled “Methods and Devices on Probability Calculation for Context-Based Adaptive Binary Arithmetic Coding,” filed on Dec. 29, 2021, the disclosures of which are incorporated by reference in their entireties for all purposes.

### FIELD

The present disclosure is related to video coding and compression, and in particular but not limited to, methods and apparatus on improving the accuracy of probability estimation module for the context-based adaptive binary arithmetic coding (CABAC) that is the entropy coding method used for modern video codecs.

### BACKGROUND

Various video coding techniques may be used to compress video data. Video coding is performed according to one or more video coding standards. For example, video coding standards include versatile video coding (VVC), high-efficiency video coding (H.265/HEVC), advanced video coding (H.264/AVC), moving picture expert group (MPEG) coding, or the like. Video coding generally utilizes prediction methods (e.g., inter-prediction, intra-prediction, or the like) that take advantage of redundancy present in video images or sequences. An important goal of video coding techniques is to compress video data into a form that uses a lower bit rate, while avoiding or minimizing degradations to video quality.

The first version of the VVC standard was finalized in July 2020, which offers approximately 50% bit-rate saving or equivalent perceptual quality compared to the prior generation video coding standard HEVC. Although the VVC standard provides significant coding improvements than its predecessor, there is evidence that superior coding efficiency can be achieved with additional coding tools. Recently, Joint Video Exploration Team (JVET) under the collaboration of ITU-T VECG and ISO/IEC MPEG started the exploration of advanced technologies that can enable substantial enhancement of coding efficiency over VVC. In April 2021, one software codebase, called Enhanced Compression Model (ECM) was established for future video coding exploration work. The ECM reference software was based on VVC Test Model (VTM) that was developed by JVET for the VVC, with several existing modules (e.g., intra/inter prediction, transform, in-loop filter and so forth) are further extended and/or improved. In future, any new coding tool beyond the VVC standard need to be integrated into the ECM platform, and tested using JVET common test conditions (CTCs).

### SUMMARY

The present disclosure provides examples of techniques relating to improving the accuracy of probability estimation module for the CABAC.

According to a first aspect of the present disclosure, there is provided a method for video decoding. The method includes that a binary arithmetic decoder may obtain a multi-hypothesis probability for a binary symbol of a given context model for the binary arithmetic decoder according to an adaptive weight, where the multi-hypothesis probability may determine a probability of the binary symbol equaling to a binary value and the binary symbol is from a plurality of binary symbols associated with the context model. Furthermore, the decoder may encode the binary symbol according to the multi-hypothesis probability. Moreover, the decoder may decode the binary symbol according to the multi-hypothesis probability.

According to a second aspect of the present disclosure, there is provided a method for video encoding. The method includes that a binary arithmetic encoder may determine a multi-hypothesis probability for a binary symbol from a plurality of binary symbols of a given context model for the binary arithmetic encoder according to an adaptive weight, where the multi-hypothesis probability indicates a probability of the binary symbol equaling to a binary value. Moreover, the encoder may encode the binary symbol according to the multi-hypothesis probability.

According to a third aspect of the present disclosure, there is provided a method for video decoding. The method includes that a decoder may select one or more slices that are coded prior to a current slice, obtain initial context states of one or more context models of the current slice by inheriting context states of one or more context models of a slice that is coded prior to the current slice, and decode binary symbols associated with the one or more context models in the current slice according to the initial context states.

According to a fourth aspect of the present disclosure, there is provided a method for video encoding. The method includes that an encoder may select one or more slices that are coded prior to a current slice, determine initial context states of one or more context models of the current slice by inheriting context states of the one or more context models from a slice that is coded prior to the current slice; and encode binary symbols associated with the one or more context models of the current slice according to the initial context states.

According to a fifth aspect of the present disclosure, there is provided an apparatus for video decoding. The apparatus includes one or more processors and a memory coupled to the one or more processors and configured to store instructions executable by the one or more processors, where the one or more processors, upon execution of the instructions, are configured to perform the method according to the first or third aspect.

According to a sixth aspect of the present disclosure, there is provided an apparatus for video encoding. The apparatus includes one or more processors and a memory coupled to the one or more processors and configured to store instructions executable by the one or more processors, where the one or more processors, upon execution of the instructions, are configured to perform the method according to the second or fourth aspect.

According to a seventh aspect of the present disclosure, there is provided a non-transitory computer-readable storage medium for storing computer-executable instructions that, when executed by one or more computer processors, cause the one or more computer processors to receive a bitstream, and perform the method according to the first or third aspect based on the bitstream.

According to an eighth aspect of the present disclosure, there is provided a non-transitory computer-readable storage medium for storing computer-executable instructions that, when executed by one or more computer processors, cause the one or more computer processors to perform the method according to the second or fourth aspect to encode the current video block into a bitstream, and transmit the bitstream.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1A is a block diagram illustrating a system for encoding and decoding video blocks in accordance with some examples of the present disclosure.

FIG. 1B is a block diagram of an encoder in accordance with some examples of the present disclosure.

FIGS. 1C-1F are block diagrams illustrating how a frame is recursively partitioned into multiple video blocks of different sizes and shapes in accordance with some examples of the present disclosure.

FIG. 2 is a block diagram of a decoder in accordance with some examples of the present disclosure.

FIG. 3A is a diagram illustrating block partitions in a multi-type tree structure in accordance with some examples of the present disclosure.

FIG. 3B is a diagram illustrating block partitions in a multi-type tree structure in accordance with some examples of the present disclosure.

FIG. 3C is a diagram illustrating block partitions in a multi-type tree structure in accordance with some examples of the present disclosure.

FIG. 3D is a diagram illustrating block partitions in a multi-type tree structure in accordance with some examples of the present disclosure.

FIG. 3E is a diagram illustrating block partitions in a multi-type tree structure in accordance with some examples of the present disclosure.

FIG. 4 is a diagram illustrating a computing environment coupled with a user interface in accordance with some examples of the present disclosure.

FIG. 5 is a flow chart illustrating a method for video decoding in accordance with some examples of the present disclosure.

FIG. 6 is a flow chart illustrating a method for video encoding corresponding to the method for video decoding as shown in FIG. 5 in accordance with some examples of the present disclosure.

FIG. 7 is a flow chart illustrating a method for video decoding in accordance with some examples of the present disclosure.

FIG. 8 is a flow chart illustrating a method for video encoding corresponding to the method for video decoding as shown in FIG. 7 in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Terms used in the disclosure are only adopted for the purpose of describing specific embodiments and not intended to limit the disclosure. “A/an,” “said,” and “the” in a singular form in the disclosure and the appended claims are also intended to include a plural form, unless other meanings are clearly denoted throughout the disclosure. It is also to be understood that term “and/or” used in the disclosure refers to and includes one or any or all possible combinations of multiple associated items that are listed.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g., devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

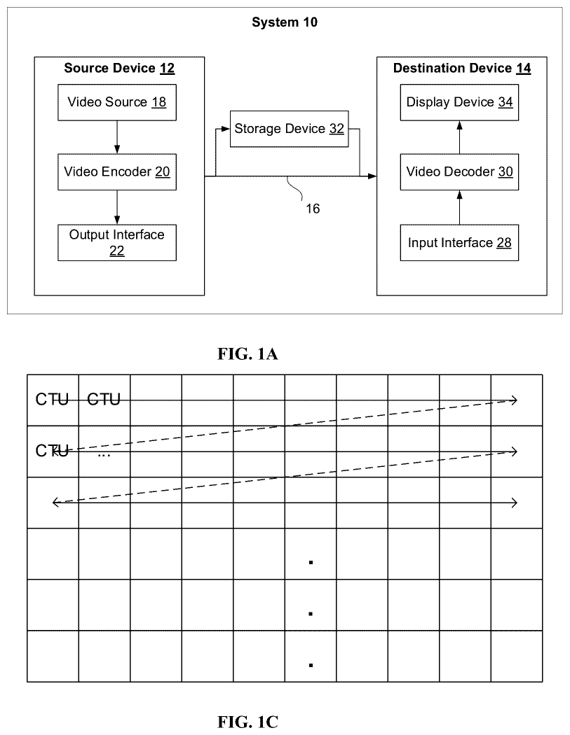

FIG. 1A is a block diagram illustrating an exemplary system 10 for encoding and decoding video blocks in parallel in accordance with some implementations of the present disclosure. As shown in FIG. 1A, the system 10 includes a source device 12 that generates and encodes video data to be decoded at a later time by a destination device 14. The source device 12 and the destination device 14 may include any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may include any type of communication medium or device capable of moving the encoded video data from the source device 12 to the destination device 14. In one example, the link 16 may include a communication medium to enable the source device 12 to transmit the encoded video data directly to the destination device 14 in real time. The encoded video data may be modulated according to a communication standard, such as a wireless communication protocol, and transmitted to the destination device 14. The communication medium may include any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1A, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may include any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

Like HEVC, VVC is built upon the block-based hybrid video coding framework. FIG. 1B is a block diagram illustrating a block-based video encoder in accordance with some implementations of the present disclosure. In the encoder 100, the input video signal is processed block by block, called coding units (CUs). The encoder 100 may be the video encoder 20 as shown in FIG. 1A. In VTM-1.0, a CU can be up to 128×128 pixels. However, different from the HEVC which partitions blocks only based on quad-trees, in VVC, one coding tree unit (CTU) is split into CUs to adapt to varying local characteristics based on quad/binary/ternary-tree. Additionally, the concept of multiple partition unit type in the HEVC is removed, i.e., the separation of CU, prediction unit (PU) and transform unit (TU) does not exist in the VVC anymore; instead, each CU is always used as the basic unit for both prediction and transform without further partitions. In the multi-type tree structure, one CTU is firstly partitioned by a quad-tree structure. Then, each quad-tree leaf node can be further partitioned by a binary and ternary tree structure.

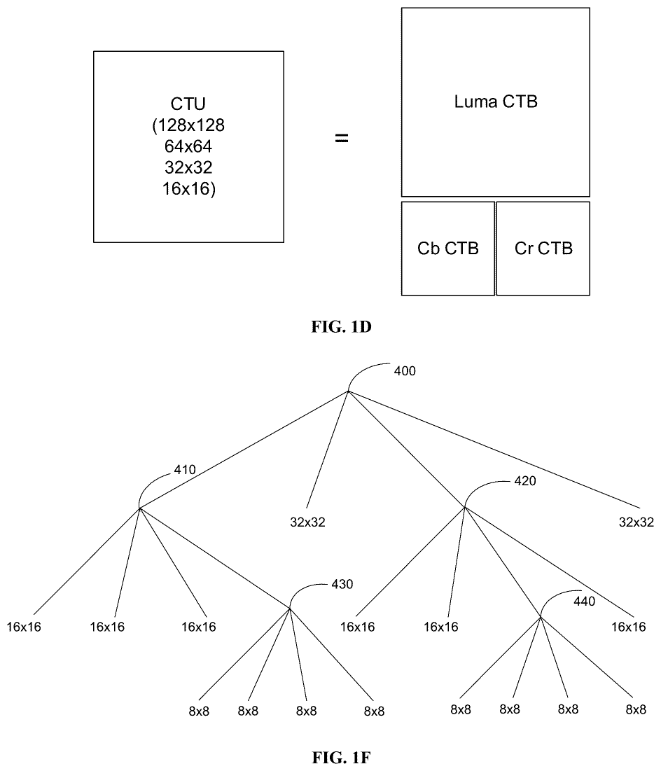

FIGS. 3A-3E are schematic diagrams illustrating multi-type tree splitting modes in accordance with some implementations of the present disclosure. FIGS. 3A-3E respectively show five splitting types including quaternary partitioning (FIG. 3A), vertical binary partitioning (FIG. 3B), horizontal binary partitioning (FIG. 3C), vertical ternary partitioning (FIG. 3D), and horizontal ternary partitioning (FIG. 3E).

For each given video block, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes.

After spatial and/or temporal prediction, an intra/inter mode decision circuitry 121 in the encoder 100 chooses the best prediction mode, for example based on the rate-distortion optimization method. The block predictor 120 is then subtracted from the current video block; and the resulting prediction residual is de-correlated using the transform circuitry 102 and the quantization circuitry 104. The resulting quantized residual coefficients are inverse quantized by the inverse quantization circuitry 116 and inverse transformed by the inverse transform circuitry 118 to form the reconstructed residual, which is then added back to the prediction block to form the reconstructed signal of the CU. Further, in-loop filtering 115, such as a deblocking filter, a sample adaptive offset (SAO), and/or an adaptive in-loop filter (ALF) may be applied on the reconstructed CU before it is put in the reference picture store of the picture buffer 117 and used to code future video blocks. To form the output video bitstream 114, coding mode (inter or intra), prediction mode information, motion information, and quantized residual coefficients are all sent to the entropy coding unit 106 to be further compressed and packed to form the bit-stream.

For example, a deblocking filter is available in AVC, HEVC as well as the now-current version of VVC. In HEVC, an additional in-loop filter called SAO is defined to further improve coding efficiency. In the now-current version of the VVC standard, yet another in-loop filter called ALF is being actively investigated, and it has a good chance of being included in the final standard.

These in-loop filter operations are optional. Performing these operations helps to improve coding efficiency and visual quality. They may also be turned off as a decision rendered by the encoder 100 to save computational complexity.

It should be noted that intra prediction is usually based on unfiltered reconstructed pixels, while inter prediction is based on filtered reconstructed pixels if these filter options are turned on by the encoder 100.

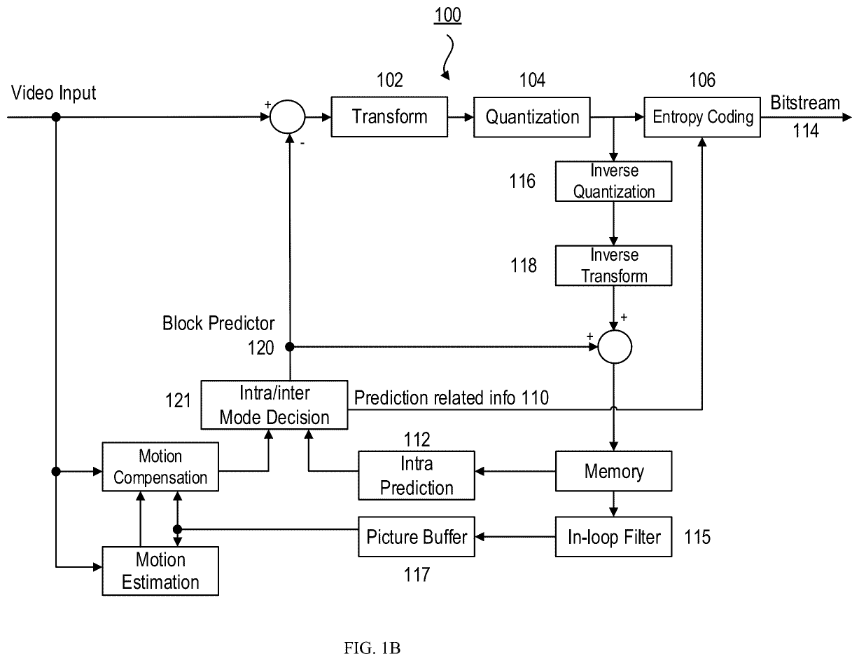

FIG. 2 is a block diagram illustrating a block-based video decoder 200 which may be used in conjunction with many video coding standards. This decoder 200 is similar to the reconstruction-related section residing in the encoder 100 of FIG. 1B. The block-based video decoder 200 may be the video decoder 30 as shown in FIG. 1A. In the decoder 200, an incoming video bitstream 201 is first decoded through an Entropy Decoding 202 to derive quantized coefficient levels and prediction-related information. The quantized coefficient levels are then processed through an Inverse Quantization 204 and an Inverse Transform 206 to obtain a reconstructed prediction residual. A block predictor mechanism, implemented in an Intra/inter Mode Selector 212, is configured to perform either an Intra Prediction 208, or a Motion Compensation 210, based on decoded prediction information. A set of unfiltered reconstructed pixels are obtained by summing up the reconstructed prediction residual from the Inverse Transform 206 and a predictive output generated by the block predictor mechanism, using a summer 214.

The reconstructed block may further go through an In-Loop Filter 209 before it is stored in a Picture Buffer 213 which functions as a reference picture store. The reconstructed video in the Picture Buffer 213 may be sent to drive a display device, as well as used to predict future video blocks. In situations where the In-Loop Filter 209 is turned on, a filtering operation is performed on these reconstructed pixels to derive a final reconstructed Video Output 222.

In the current VVC and AVS3 standards, motion information of the current coding block is either copied from spatial or temporal neighboring blocks specified by a merge candidate index or obtained by explicit signaling of motion estimation. The focus of the present disclosure is to improve the accuracy of the motion vectors for affine merge mode by improving the derivation methods of affine merge candidates. To facilitate the description of the present disclosure, the existing affine merge mode design in the VVC standard is used as an example to illustrate the proposed ideas. Please note that though the existing affine mode design in the VVC standard is used as the example throughout the present disclosure, to a person skilled in the art of modern video coding technologies, the proposed technologies can also be applied to a different design of affine motion prediction mode or other coding tools with the same or similar design spirit.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

As shown in FIG. 1C, the video encoder 20 (or more specifically a partition unit in a prediction processing unit of the video encoder 20) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 1D, each CTU may include one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may include a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 1E, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 1F depicts a quad-tree data structure illustrating the end result of the partition process of the CTU 400 as depicted in FIG. 1E, each leaf node of the quad-tree corresponding to one CU of a respective size ranging from 32×32 to 8×8. Like the CTU depicted in FIG. 1D, each CU may include a CB of luma samples and two corresponding coding blocks of chroma samples of a frame of the same size, and syntax elements used to code the samples of the coding blocks. In monochrome pictures or pictures having three separate color planes, a CU may include a single coding block and syntax structures used to code the samples of the coding block. It should be noted that the quad-tree partitioning depicted in FIGS. 1E-IF is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIGS. 3A-3E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may include a PB of luma samples, two corresponding PBs of chroma samples, and syntax elements used to predict the PBs. In monochrome pictures or pictures having three separate color planes, a PU may include a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 1E, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may include a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUS of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit as described above in connection with FIG. 1B, the motion vector predictor of the current CU is subtracted from the actual motion vector of the current CU to produce a Motion Vector Difference (MVD) for the current CU. By doing so, there is no need to encode the motion vector determined by the motion estimation unit for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

The main goal of the disclosure is to enhance the efficiency of the CABAC techniques that are used in hybrid video coding framework. Specifically, several improvements are proposed to increase the accuracy of the probability estimation for the serial of binary symbols (also known as bins in short) of syntax elements that are generated when compressing video signal. In the following, in-depth analysis of the existing CABAC techniques that are applied in the modern video coding standards, such as AVC, HEVC and VVC, are firstly provided. Then, some deficiencies/limitations in the existing CABAC design are discussed. After that, methods are proposed for improved CABAC efficiency through increasing the accuracy of the probability estimation.

### The Probability Estimation Technique for the CABAC in the AVC and HEVC

The CABAC was originally introduced in the H.264/AVC standard, as one of two supported entropy coding schemes. In the CABAC, arithmetic coding is composed of two modules: codeword mapping (also known as binarization) and probability estimation. In the process of codeword mapping, the syntax elements are mapped into strings of bins. The mapping is realized by the so-called binarizer which translates the syntax elements into several group of bins based on different binarization schemes. In practice, various binarization schemes may be applied for such translation, such as fixed-length code, unary code, truncated unary code, and kth-order Exponential-Golomb code and so forth. The purpose of the probability estimation module is to determine the likelihood of one bin having the value of 1 or 0. In the AVC, the probabilities of bins are calculated based on an exponential aging model, where the probability that one current bin is equal to 1 or 0 is dependent on the values of previous bins that are previously coded. Additionally, according to common data statistics, the influence of bins that are immediately precede one current bin are usually larger than the bins that are coded long ago. Taking such into consideration, one parameter α is introduced in the CABAC, which controls the number N of previously coded bins that are used to estimate the probability of the current bin, i.e., N=1/α. The parameter translates into the adaptation speed with which the probability is updated along with the increased coded bins. Specifically, with the adaptation parameter α, the probability that one bin is the least probable symbol (LPS) is calculated recursively as

$$p ( t + 1 ) = p ( t ) \cdot ( 1 - α ) + x ( t ) \cdot α \qquad ( 1 )$$

where p(t) is the probability of the LPS symbol at instant t; p(t+1) is the updated probability of the LPS symbol at instant t+1; x(t) is equal to 1 when the current bin is LPS symbol and 0 when the current bin is the most probable symbol (MPS). In the CABAC engine of the AVC and the HEVC, the probability is independently updated according to (1) for each syntax element with a fixed value of α≈1/19.69, i.e., around 19.69 previously coded bins are considered when estimating the probability of one current bin. Moreover, in order to avoid multiplications during the probability estimation, the probability p(t) in equation (1), which is real number and ranges from 0 to 1, is quantized into a set of fixed probability states. For example, in both the AVC and the HEVC, the probability has 7-bit precision, corresponding to 128 probability states.

In the AVC and the HEVC, a video bitstream usually consists one or more independently decodable slices. At beginning of each slice, the probabilities of all the contexts are initialized to some pre-defined values. Theoretically, with knowing the statistic nature of one given context, uniform distribution (i.e., Pinit=0.5) should be used to initialize the context probability. However, to enable a faster catchup of the probability of one context to its corresponding statistical distribution, it was found that to be beneficial to provide some appropriate initial probability values (which may not be equiprobable) for each context. Specifically, in the AVC and HEVC, given the initial QP of one slice SliceQPY, the initial probability state of one context InitProbState is calculated as follows:

$$m = SlopeIdx \cdot 5 - 45 \qquad ( 2 )$$

$$n = ( OffsetIdx ≪ 3 ) - 16$$

$$InitProbState = Clip 3 ( 1 , 127 , ( m \cdot {SliceQP}_{Y} ) ≫ 4 + n )$$

where SlopeIdx and OffsetIdx (both in the range from 0 to 15) are two initialization parameters, which are predefined and stored as look-up table (LUT), to calculate the initial probability of one context. As shown in equation (2), the initial probability state is modeled by a linear function of the slice QP with the slope equal to (m>>4) and the offset equal to n.

### The Probability Estimation Technique for the CABAC in the VVC

The probability estimation module that is applied in the VVC is kept almost the same as that in the AVC and HEVC, except for the following key differences: First, VVC maintains two probability estimates for each context, where each has its own probability adaptation rate a in equation (1). The final probability that is actually used for arithmetic coding is the average of the two estimates; second, in the VVC, multiple probability LUTs are predefined and used to initialize the probabilities of different contexts of one slice. Meanwhile, similar to the AVC and the HEVC, the initial estimate of the probability is built upon one linear model taking the slice QP as the input. However, in the VVC, the derived value represents the actual probability value; whereas in the AVC/HEVC, it represents the index of the probability state.

### Multi-Hypothesis Probability Estimation

It is obvious that using one fixed adaptation parameter for all the syntax elements may not be optimal due to their different statistical characteristics. On the other hand, it has been proven in several scientific research that better estimation accuracy can be achieved by using multiple probability estimators compared to one single estimator. Therefore, one multi-hypothesis probability estimation scheme is applied in the CABAC design of the VVC, where two different adaptation parameter α₀ and α₁ are utilized, which correspond to one slow and fast speed for the probability adaptation. By such way, two different probabilities can be calculated for each bin using two adaptation parameters, which are then averaged to generate the final probability of the bin, i.e.,

$${p}_{0} ( τ + 1 ) = {p}_{0} ( τ ) \cdot ( 1 - {α}_{0} ) + x ( t ) \cdot {α}_{0} \qquad ( 3 )$$

$${p}_{1} ( t + 1 ) = {p}_{1} ( t ) \cdot ( 1 - {α}_{1} ) + x ( t ) {α}_{1}$$

$$p ( t + 1 ) = ( {p}_{0} ( t + 1 ) + {p}_{1} ( t + 1 ) ) / 2$$

where α0 and α1 are the two adaptation parameters associated with the two probability hypotheses. In the VVC, the values of α₀ and α₁ are independently selected for each context using one training algorithm that is designed to jointly optimize the adaptation parameters as well as the initial probabilities. Specifically, according to the current design, each context is allowed to select α₀ from one set of predefined values of {¼, ⅛, 1/16, 1/32} and α₁ from another set of predefined values of { 1/32, 1/64, 1/128, 1/256, 1/512}.

### Initial Probability Calculation

As in the AVC/HEVC, the CABAC process of the VVC also invoke one QP dependent probability initialization process at the beginning of each slice. However, compared to the AVC/HEVC which initializes the state of one probability state machine, the actual value of the initial probability is directly derived, as depicted as

$$m = ( SlopeIdx ≫ 3 ) - 4 \qquad ( 4 )$$

$$n = ( ( OffsetIdx \& 7 ) \cdot 18 ) + 1$$

$$InitState = Clip 3 ( 1 , 127 , ( m \cdot ( {SliceQP}_{Y} - 16 ) ) ≫ 1 + n )$$

$${p}_{0}^{init} = initState ≪ 7$$

$${p}_{1}^{init} = initState ≪ 3$$

where SlopeIdx and OffsetIdx are two initialization parameters for calculating the slope and offset of the linear model, each being represented in the precision of 3 bit; p₀^{init} and p₀^{init} are the two initial probabilities calculated for two probability estimators.

### Problem Statement

Compared to the CABAC design in the AVC/HEVC, the probability estimation scheme in the VVC can more precisely capture the true statistical distribution of the bins for each context, leading to the improved CABAC efficiency. However, its design can still be further improved. Specifically, the following deficiencies that exist in the current probability estimation of the VVC CABAC process are identified in this disclosure:

First, as discussed above, in the VVC, multi-hypothesis-based probability estimation scheme is applied, where two probability estimators (one with a fast adaption rate and the other with a slow adaptation rate), to estimate the probability of the bins for each context model. Additionally, in the existing design, the probability of one bin is just a simple average of the two probability estimators. Such design is suboptimal given that the fixed weight may not be flexible enough to adapt to the varying data statistics of different contexts.

On the other hand, according to the existing VVC design, the probabilities of all the contexts in one slice are initialized based on three sets of initial context values, which are predetermined for different slice types (i.e., I, B and P slices). Among those, the set of the initial context values of I slice type is only allowed to be used for I slices while the set of the initial context values of B and P slices are allowed to be used for either B or P slices. Due to its specific features, the bins of each video bitstream usually presents very different statistical characteristics from each other. Therefore, using only three fixed sets of initial context values seems far from optimal to offer efficient starting points for the probability estimator to fast capture the true probability distortion of each context. On the other hand, due to the strong temporal correlation within one video sequence, the probability statistics of the contexts from the slices that are coded before the current slice can potentially provide more accurate estimates to initialize the probabilities of the contexts in the current slice.

In the present disclosure, methods are proposed to resolve the problems/deficiencies in the existing probability estimation scheme in the VVC. Specifically, the following methods are proposed to further improve the probability estimation accuracy while considering the friendliness to hardware codec implementations.

First, to enhance the precision of probability estimation, one binary arithmetic coding with weighted multi-hypothesis probability update is proposed. Specifically, instead of using simple average, the final probability used for coding one bin of each context is calculated as one weighted combination of two probability estimators p0 and p1 that are associated with the context. Additionally, multiple initialization methods are proposed to indicate the initial weight parameters for the contexts at the beginning of one slice.

Second, one improved initialization scheme is proposed to initialize the state parameters of the contexts for the slices that are inter coded. Specifically, in addition to using the existing fixed context initialization tables, the proposed scheme allows to initialize the state parameters of the contexts (e.g., the two probability estimators, the adaptation rates and the weighting factors for the combination of two probability estimators in one inter-coded slice to be copied from the corresponding state parameters of the slices that are previously coded.

Multi-Hypothesis Probability Estimation with Adaptive Weights

In the VVC, multi-hypothesis-based probability estimation is applied where the final probability when coding each bin of one context is calculated as the average of two probability estimators. Given the specific statistic characteristics of different video bitstreams, it is obvious that such scheme (i.e., using the equal weight (i.e., 0.5)) may not be always flexible enough to capture the true symbol statistics when combining the two probability estimators of one context. Therefore, in this section, one multi-hypothesis probability estimation with adaptive weights (MHP-AW) to further improve the probability estimation accuracy of the VVC. Specifically, same to the VVC CABAC design, two separate probability estimators p₀ and p₁ are maintained for each context and updated based on their own adaption rates α₀ and α₁. However, instead of using fixed average, multiple weight parameters are introduced in the proposed scheme where the final probability p that is used for the binary arithmetic coding of one context is derived based on the weighted combination of the two probability estimators. In detail, the proposed probability estimation can be formulated as

$${p}_{0} ( t + 1 ) = {p}_{0} ( t ) \cdot ( 1 - {α}_{0} ) + x ( t ) \cdot {α}_{0} \qquad ( 5 )$$

$${p}_{1} ( t + 1 ) = {p}_{1} ( t ) \cdot ( 1 - {α}_{1} ) + x ( t ) \cdot {α}_{1}$$

$$p ( t + 1 ) = ( 1 - ω ) \cdot {p}_{0} ( t ) + ω \cdot {p}_{1} ( t )$$

where ω is the weight that is used for the combination of two probability estimations, whose value is obtained from the range [0, 1]. In equation (5), the weight w represent one real value, which needs to be quantized into integers for hardware/software codec implementations. In practice, different methods may be applied to convert the value of ω into integers. For instance, one uniform quantizer with quantization step qₛₜₑₚ may be applied to approximate the real weight value by the multiplication of one integer and the quantization step, as described as

$$ω = {ω}^{int} \cdot {q}_{step} \qquad ( 6 )$$

where ω^{int} is the integer weight value. Further, the quantization step which is also one real value can be approximated as one right shift operation of M-bit as

$$ω = {ω}^{int} \cdot {q}_{step} = {ω}^{int} ≫ M \qquad ( 7 )$$

As shown in equation (7), additional memory is required to store the set of the integer weight values ω^{int}'s, when implementing the proposed MHP-AW scheme in hardware/software. Meanwhile, as illustrated in equation (5), the precision of the integer weights (i.e., M) also determines the bit-width of the multiplier that is need for the weighted combination of the two probability estimators. Therefore, in practice, different set of integer weight values and representation precisions may be applied to achieve various trade-off between coding efficiency and hardware/software implementation complexity. For instance, assuming the representation precision M equal to 5, different set of integer values may be applied. In one example, it is proposed to select the optimal weight of each context from one predefined set {0, 3, 6, 10, 13, 16, 19, 22, 26, 29, 32}. In another example, it is proposed to set the weight from one predefined set {0, 6, 11, 16, 21, 26, 32}. In yet another example, it is proposed to use the predefined set of integer weight values {0, 8, 12, 16, 20, 24, 32}.

Similar to the probability and adaption rate, in the proposed MHP-AW scheme, one initial value of the weight ω^{int} needs to be provided for each context at the beginning of one slice. In the following, different schemes are proposed for the initialization of the MHP-AW weights. In the first method, it is proposed to define a plurality of different predefined tables, each containing a set of weight initialization values for all the contexts in one slice Before encoding/decoding one slice one predefined table may be selected and the corresponding MHP-AW weights are initialized based on the corresponding weight values of the table. For instance, in one embodiment, a number of slice-type-dependent initial weight tables may be derived, e.g., three sets of weight initialization tables designed specifically for I, P and B slices. By such way, for one slice, video encoder may select one from the three predefined tables to initialize the MHP-AW weights to better adapt to the symbol statistics in the slice. When such scheme is applied, one additional syntax element sh_cabac_weight_init_idx may be signaled for each slice, indicating which initial weight table is selected for the slice, as illustrated as in Table 1 below:

TABLE 1

| | Descriptor |
|---|---|
| slice_header( ) { | |
| ...... | |
| if( pps_cabac_weight_init_present_flag ) | |
| sh_cabac_weight_init_idx | ue(v) |
| ...... | |
| } | |

where the syntax pps_cabac_weight_init_present_flag is one control flag that is signaled in picture parameter set (PPS) indicating whether it is allowed to select different initial weight tables for each slice. When the flag is enabled, another syntax sh_cabac_weight_init_idx is further signaled at slice level to indicate the selected initial weight table. In another embodiment, it is proposed to only allow the MHP-AW weights of I slice to be initialized by the initial weight table associated with the I slice type while the MHP-AW weights of P and B slices are allowed to be initialized from one of the predefined weight initialization tables. Specifically, in addition to the initial weight table associated with the slice type of the current slice, it is proposed to only allow one P (or B) slice to be initialized with the initial weight table of B (or P) slice type. Correspondingly, in such case, only one flag needs to be signaled for each slice for the initial table selection of the MHP-AW weights for P/B slices, as depicted in Table 2 below:

TABLE 2

| | Descriptor |
|---|---|
| slice_header( ) { | |
| ...... | |
| if( sh_slice_type != I ) { | |
| if( pps_cabac_weight_init_present_flag ) | |
| sh_cabac_weight_init_idx | ue(v) |
| } | |
| ...... | |
| } | |

When the flag sh_cabac_weight_init_flag is equal to 0, it means that the initial weight table corresponding to the slice type of the current slice is used to initialize the values of the MHP-AW weights of the slice; When the flag is equal to 1, it means that the initial weight table corresponding to P slice type is used to initialize the values of the MHP-AW weights in the slice when the current slice is one B slice and the initial weight table corresponding to B slice type is used to initialize the values of the MHP-AW weights in the slice when the current slice is one P slice.

Further, in another embodiment of the present disclosure, it is proposed to extend the existing CABAC initialization tables to include the corresponding MHP-AW weight for each context. Specifically, after such change, each element of one CABAC initialization table contains three different categories of information, including 1) the initial probability values, 2) the adaption rates used to initialize the probabilities and adaptation speeds of two probability hypotheses, and 3) the MHP-AW weight used to combine the two hypotheses when updating the probability of each context. Similar to the existing VVC design, when such scheme is applied, a plurality of CABAC initialization tables may be pre-determined and the syntax elements may be signaled from encoder to decoder to inform which initialization table will be selected for each slice to initialize the corresponding values of the two probabilities, the two adaption rates as well as the combination weight associated with each slice. In one specific embodiment, it is proposed to reuse the existing CABAC initialization syntax elements, i.e., pps_cabac_init_present_flag and sh_cabac_init_flag, to indicate the selection of the CABAC initialization table at slice. When such method is applied, the CABAC states (ie probabilities adaptation rates and combination weight) of I slice are only allowed to be initialized by the initialization table of the I slice type while the CABAC states of P (or B) slice are allowed to be initialized with the initialization tables of the B (or P) slice type. In another embodiment, it is proposed to predetermine a number of the CABAC tables (>3) and the CABAC states of one slice are allowed to be arbitrarily initialized from one of the predefined tables.

In all the above methods, fixed values are used to initialize the MHP-AW weights of the contexts when coding one slice, which may not be accurate to provide reliable probability estimation for arithmetic coding. To resolve such issue, it is proposed to give encoder the flexibility to calculate the optimal MHP-AW weights for each slice and signal the corresponding optimal MHP-AW weights to decoder.

In one embodiment, it is proposed to directly signal the weight value of each context element. For instance, one flag may be firstly signaled to indicate whether the MHP-AW weights of the contexts in the slice are initialized with one fixed initialization table. When the flag is equal to one, another syntax element may be signaled to inform the decoder which weight initialization table is applied to the current slice; otherwise, i.e., the flag is equal to 0, the MHP-AW weights of the contexts in the slice will be initialized by the values that are parsed from the bitstream. In practice, different binarization methods may be applied to generate the codewords of the MHP-AW weight values, e.g., fixed-length code, unary code, k-th order Exponential-Golomb code and so forth.

In another embodiment, one adaptive signaling method is proposed. Specifically, at the beginning of each slice, the scheme firstly transmits a binary map weightMap[ ] from encoder to decoder, where each element indicates whether the corresponding context uses the initialized weight values from the selected default initialization weight table. When the i-th weightMap[ ] map entry is equal to 0, it means that the MHP-AW weight of the i-th context of the current slice will be initialized by the corresponding values in the select initialization weight table. When the i-th weightMap[ ] map entry is equal to 1, it means that the MHP-AW weight of the i-th context of the current slice will be initialized by the initial value that is indicated in the bitstream. Different methods may be applied to code the map weightMap[ ]. In one example, it is proposed to use run-length coding to code the binary values of the map where one “run” values are sent to indicate the number of consecutive 0s (or 1s) before one 1 (or 0) is met.

Initial CABAC State Inheritance from Previously Coded Slices

As discussed above, the symbols of the same context in different video bitstreams usually present quite different statistical characteristics. Given that the probability states are fixed in the predefined CABAC table and are not able to adapt to the specific features of different slices. There is potential coding efficiency drop when the predefined initial table deviates from the true symbol statistics of the video bitstream. To improve the CABAC efficiency, improved CABAC initialization schemes are proposed for the initialization of the contexts from the context states after encoding/decoding one previous slice. There may be different ways to identify the previous slice for the CABAC initialization.

In one embodiment, it is proposed to maintain the output context states of N previously coded slices. When one current slice is encoded, a video encoder will select the best one from the N previously coded slices and signal one index to decoder to initialize the contexts of the current slice from the corresponding context states of the selected previously coded slice (as indicated by the signaled index value).

In other embodiments, instead of directly signaling the selected previously coded slice in bitstreams, some implicit decoder-side selection schemes may be applied to select the corresponding previously coded slice for the context initialization of the current slice, including:
Rule #1: It is proposed to directly select the slice that is coded just before the slice according to the coding order.
Rule #2: It is proposed to select the previously coded slice that is closest to the current slice according to the order and has the same slice type.
Rule #3: It is proposed to select the previously coded slice that is closest to the current slice according to the order and has the smallest QP difference to the current slice.
Rule #4: It is proposed to select the previously coded slice that is closest to the current slice according to the order and has the same temporal layer as the current slice.

Although the above implicit selection rules are proposed separately, it may also be combined and applied together in the proposed initial CABAC state inheritance scheme. In one specific example, it is proposed to combine Rule #2, #3 and #4 together. Specifically, based on such combination, encoder/decoder may select the previously coded slice in the same slice type, which is closest to the current slice according to the coding order and has the smallest QP difference to the current slice. In case such previously coded slice does not exist, one of the existing predefined CABAC initialization tables may be applied to initial the context states of the current slice.

Additionally, in the proposed inheritance-based context initialization scheme, the inherited context states may include different categories of state information, e.g., the probability values, the adaption rates and the combination weights (when the proposed MHP-AW scheme is applied). In one embodiment of the disclosure, it is proposed to only inherit one state information from the selected previously coded slice while the other state information of the current slice is initialized using the existing predefined CABAC initialization tables. In another embodiment, it is proposed to only inherit two state information from the selected previously coded slice. In yet another embodiment, it is proposed to inherit all the state information of the current slice from the corresponding context states of the selected previously coded slice.

Though it can improve the efficiency of context initialization, the above inheritance-based CABAC initialization may introduce parsing dependency between different slices. This is because the entropy coding of one current slice cannot be invoked until the entropy coding of its reference slice (i.e., the selected previously coded slice) is fully finished.

To provide a better control of the efficiency and the parallelism of entropy coding, one adaptive CABAC initialization scheme is proposed in which the context states of one current slice may be initialized by one of two ways: 1) to be initialized by using one of the predefined CABAC initialization tables; or 2) to be initialized by the resulting context states of one previously coded slice. Specifically, in the proposed scheme, one binary flag is firstly signaled at the beginning of one slice. When the flag is equal to zero, it means the contexts of the current slice will be initialized by one of the existing predefined CABAC initialization tables, e.g., as indicated by the syntax element sh_cabac_init_flag. When the flag is equal to one, it means that the inheritance-based context initialization method will be applied, where the initialize context values will be set to be the context states output from the selected slice that is coded ahead the current slice.

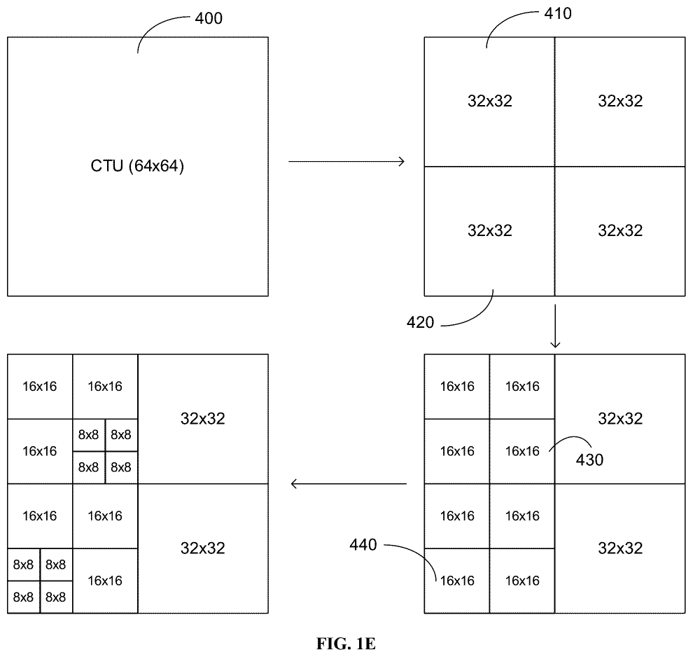

FIG. 4 shows a computing environment (or a computing device) 410 coupled with a user interface 460. The computing environment 410 can be part of a data processing server. In some embodiments, the computing device 410 can perform any of various methods or processes (such as encoding/decoding methods or processes) as described hereinbefore in accordance with various examples of the present disclosure. The computing environment 410 may include a processor 420, a memory 440, and an I/O interface 450.

The processor 420 typically controls overall operations of the computing environment 410, such as the operations associated with the display, data acquisition, data communications, and image processing. The processor 420 may include one or more processors to execute instructions to perform all or some of the steps in the above-described methods. Moreover, the processor 420 may include one or more modules that facilitate the interaction between the processor 420 and other components. The processor may be a Central Processing Unit (CPU), a microprocessor, a single chip machine, a GPU, or the like.

The memory 440 is configured to store various types of data to support the operation of the computing environment 410. Memory 440 may include predetermine software 442. Examples of such data include instructions for any applications or methods operated on the computing environment 410, video datasets, image data, etc. The memory 440 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The I/O interface 450 provides an interface between the processor 420 and peripheral interface modules, such as a keyboard, a click wheel, buttons, and the like. The buttons may include but are not limited to, a home button, a start scan button, and a stop scan button. The I/O interface 450 can be coupled with an encoder and decoder.

In some embodiments, there is also provided a non-transitory computer-readable storage medium including a plurality of programs, such as included in the memory 440, executable by the processor 420 in the computing environment 410, for performing the above-described methods. For example, the non-transitory computer-readable storage medium may be a ROM, a RAM, a CD-ROM, a magnetic tape, a floppy disc, an optical data storage device or the like.

The non-transitory computer-readable storage medium has stored therein a plurality of programs for execution by a computing device having one or more processors, where the plurality of programs when executed by the one or more processors, cause the computing device to perform the above-described method for motion prediction.

In some embodiments, the computing environment 410 may be implemented with one or more application-specific integrated circuits (ASICs), digital signal processors (DSPs), digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

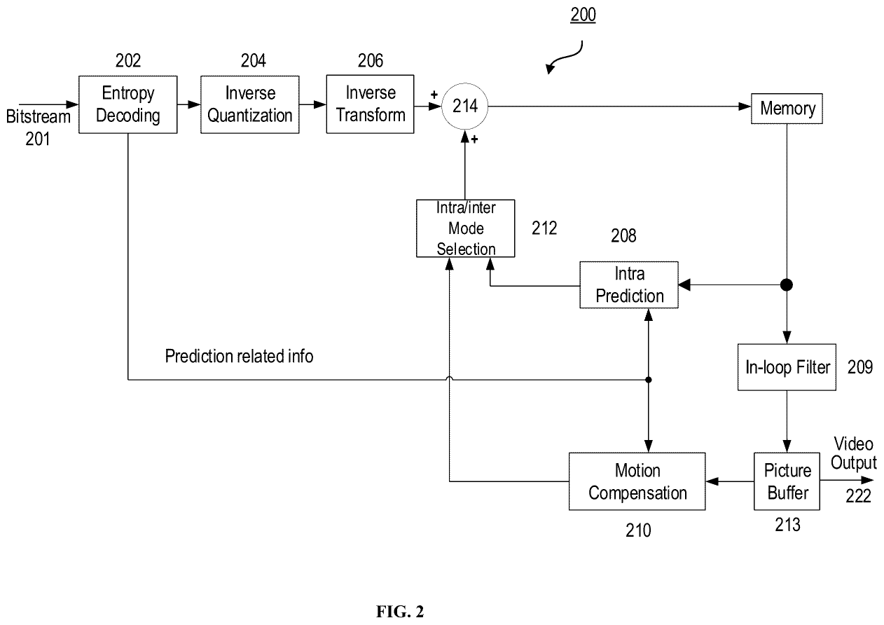

FIG. 5 is a flowchart illustrating a method for video decoding according to an example of the present disclosure.

In step 501, the processor 420, at the side of one binary arithmetic decoder may obtain a multi-hypothesis probability for one binary symbol of one given context model for the binary arithmetic decoder according to an adaptive weight, where the multi-hypothesis probability indicates a probability of the one binary symbol equaling to a binary value, and the one binary symbol is from a plurality of binary symbols associated with the context model.

For example, the adaptive weight may be the weight ω in equation (5) that is used for the combination of two probability estimations, whose value is obtained from the range [0, 1]. In equation (5), the weight ω represent one real value, which needs to be quantized into integers for hardware/software codec implementations. In practice, different methods may be applied to convert the value of into integers. As such, the multi-hypothesis probability is the combination of two probability estimations using the adaptive weight ω.

In some examples, the processor 420 may obtain a first probability for the one binary symbol according to a first adaptation parameter and obtain a second probability for the one binary symbol according to a second adaption parameter. Furthermore, the processor 420 may obtain the multi-hypothesis probability according to the adaptive weight, the first probability, and the second probability. For example, the first probability may be p₀(t+1) in equation (5) while the second probability may be p₁(t+1) in equation (5).

In some examples, the processor 420 may obtain the adaptive weight according of the context model from a set of predetermined integer weight values in a weight initialization table.

As discussed in the section of “Multi-hypothesis probability estimation with adaptive weights,” it is proposed to select the optimal weight of each context from one predefined set. For example, it is proposed to use the predefined set of integer weight values {0, 3, 6, 10, 13, 16, 19, 22, 26, 29, 32}, {0, 6, 11, 16, 21, 26, 32}, or {0, 8, 12, 16, 20, 24, 32}.

In some examples, the decoder may obtain a weight initialization table for each slice type, select the weight initialization table according to the first slice type, where the first slice type includes an I type, P type, or a B type in response to determining that a current slice is a first slice type, selecting, by the decoder, and obtain the adaptive weight according to the weight initialization table that is selected.

In some examples, the processor 420 may obtain at a lice level an adaptive weight syntax element for each slice indicating a weight initialization table selected for each slice according to a slice type of each slice in response to determining that the control syntax element is enabled.

In some examples, the processor 420 may obtain a first weight initialization table for each I slice, a second weight initialization table for each P slice, and a third weight initialization table for each B slice. Furthermore, the processor 420 may select the first weight initialization table in response to determining that a current slice is an I slice and select the second weight initialization table or the third weight initialization table in response to determining that the current slice is a P slice or a B slice, and obtain the adaptive weight according to a selected weight initialization table, as indicated in Table 2. The selected weight initialization table may be one of the first weight initialization table, the second weight initialization table, or the third weight initialization table.

In step 502, the processor 420 may decode the one binary symbol according to the multi-hypothesis probability.

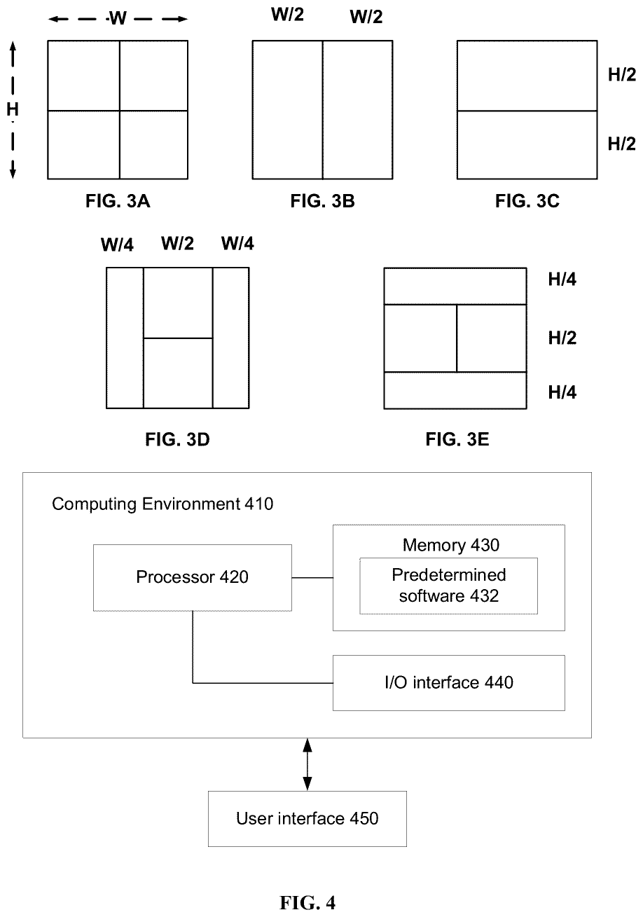

FIG. 6 is a flowchart illustrating a method for video encoding corresponding the method for video decoding as shown in FIG. 5.

In step 601, the processor 420, at the side of one binary arithmetic decoder, may determine a multi-hypothesis probability for one binary symbol of one given context model for the binary arithmetic decoder according to an adaptive weight, where the multi-hypothesis probability indicates a probability of the one binary symbol equaling to a binary value, and the one binary symbol is from a plurality of binary symbols associated with the context model. For example, the encoder may obtain the multi-hypothesis probability for one binary symbol of one given context model for the binary arithmetic decoder according to an adaptive weight.

For example, the adaptive weight may be the weight ω in equation (5) that is used for the combination of two probability estimations, whose value is obtained from the range [0, 1]. In equation (5), the weight ω represent one real value, which needs to be quantized into integers for hardware/software codec implementations. In practice, different methods may be applied to convert the value of the adaptive weight into integers. As such, the multi-hypothesis probability is the combination of two probability estimations using the adaptive weight ω.

In some examples, the processor 420 may determine a first probability for the one binary symbol according to a first adaptation parameter and determine a second probability for the one binary symbol according to a second adaption parameter. Furthermore, the processor 420 may determine the multi-hypothesis probability according to the adaptive weight, the first probability, and the second probability. For example, the first probability may be p₀(t+1)) in equation (5) while the second probability may be p₁(t+1) in equation (5).

In some examples, the processor 420 may determine the adaptive weight according of the context model from a set of predetermined integer weight values in a weight initialization table.

As discussed in the section of “Multi-hypothesis probability estimation with adaptive weights,” it is proposed to select the optimal weight of each context from one predefined set. For example, it is proposed to use the predefined set of integer weight values {0, 3, 6, 10, 13, 16, 19, 22, 26, 29, 32}, {0, 6, 11, 16, 21, 26, 32}, or {0, 8, 12, 16, 20, 24, 32}.

In some examples, the decoder may determine a weight initialization table for each slice type, select the weight initialization table according to the first slice type, where the first slice type includes an I type, P type, or a B type in response to determining that a current slice is a first slice type, selecting, by the decoder, and obtain the adaptive weight according to the weight initialization table that is selected.

In some examples, the processor 420 may determine at a lice level an adaptive weight syntax element for each slice indicating a weight initialization table selected for each slice according to a slice type of each slice in response to determining that the control syntax element is enabled.

In some examples, the processor 420 may determine a first weight initialization table for each I slice, a second weight initialization table for each P slice, and a third weight initialization table for each B slice. Furthermore, the processor 420 may select the first weight initialization table in response to determining that a current slice is an I slice and select the second weight initialization table or the third weight initialization table in response to determining that the current slice is a P slice or a B slice, and determine the adaptive weight according to a selected weight initialization table, as indicated in Table 2. The selected weight initialization table may be one of the first weight initialization table, the second weight initialization table, or the third weight initialization table.

In step 602, the processor 420 may encode the one binary symbol according to the multi-hypothesis probability. For example, the encoder may encode the one binary symbol according to the multi-hypothesis probability.

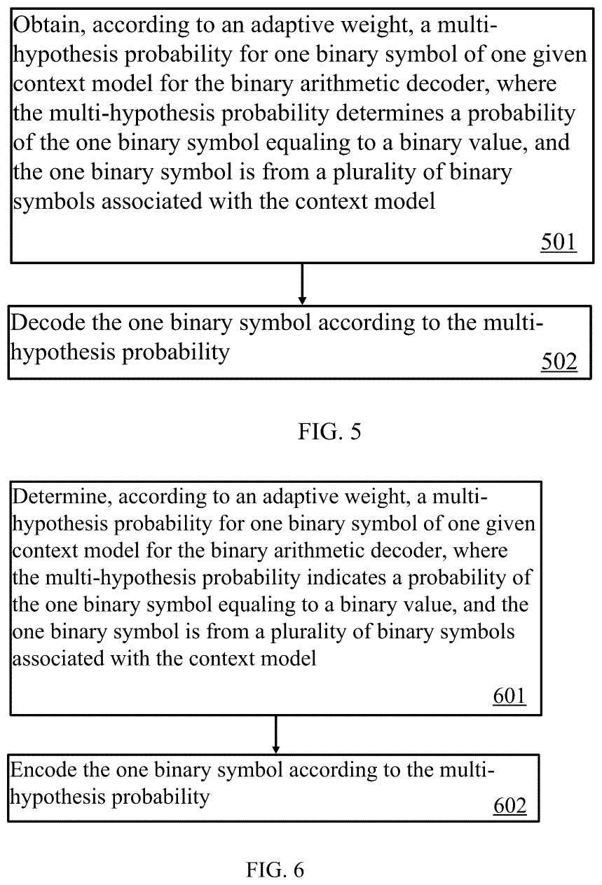

FIG. 7 is a flowchart illustrating a method for video decoding according to an example of the present disclosure.

In step 701, the processor 420, at the side of a decoder, may select one or more slices that are coded prior to a current slice.

For example, the one or more slices may be N previously coded slices as discussed in the section of “Initial CABAC state inheritance from previously coded slices.” When one current slice is encoded, a video encoder will select the best one from the N previously coded slices and signal one index to decoder to initialize the contexts of the current slice from the corresponding context states of the selected previously coded slice (as indicated by the signaled index value).

In some examples, the one or more slices may include a slice that is coded immediately before the current slice.

In some examples, the one or more slices may include a slice that is not coded immediately before the current slice, and the slice meets at least one of following conditions: the slice has a same slice type as the current slice; the slice has a smallest quantization parameter (QP) difference to the current slice; or the slice has a same temporal layer as the current slice.

For example, some implicit decoder-side selection schemes may be applied to select the corresponding previously coded slice for the context initialization of the current slice according to Rule #1, Rule #2, Rule #3, Rule #4, or any combination of these Rules.

In step 702, the processor 420 may obtain initial context states of one or more context models of the current slice by inheriting context states of one or more context models of one slice that is coded prior to the current slice.

By inheriting the context states, the one or more context models of the current slice will use the context states of the one or more context models of one previously coded slice (i.e., the one slice that is coded prior to the current slice) as the initial context states.

In some examples, the one or more initial context states may include at least one of following parameters: a probability value, an adaption rate, or an adaptive weight.

For example, the inherited context states may include different categories of state information, e.g., the probability values, the adaption rates and the combination weights (when the proposed MHP-AW scheme is applied). In one embodiment of the disclosure, it is proposed to only inherit one state information from the selected previously coded slice while the other state information of the current slice is initialized using the existing predefined CABAC initialization tables. In another embodiment, it is proposed to only inherit two state information from the selected previously coded slice. In yet another embodiment, it is proposed to inherit all the state information of the current slice from the corresponding context states of the selected previously coded slice.

In some examples, the processor 420 may obtain at least one second initial context state of the current slice according to one or more existing context-based adaptive binary arithmetic coding (CABAC) initialization tables, where the current slice includes the initial context state and the at least one second initial context state. Furthermore, the processor 420 may decode the binary symbols in the current slice according to the initial context states and the at least one second initial context state.

In step 703, the processor 420 may decode binary symbols associated with the one or more context models in the current slice according to the initial context states.

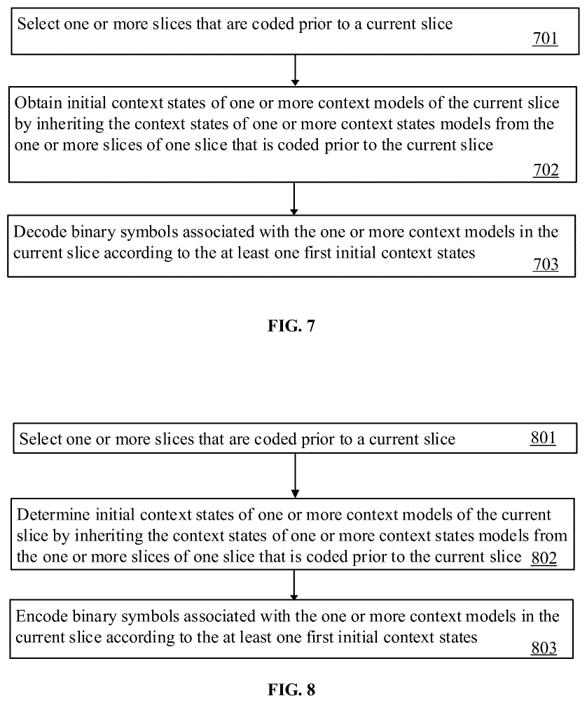

FIG. 8 is a flowchart illustrating a method for video encoding corresponding the method for video decoding as shown in FIG. 7.

In step 801, the processor 420, at the side of an encoder, may select one or more slices that are coded prior to a current slice.

For example, the one or more slices may be N previously coded slices as discussed in the section of “Initial CABAC state inheritance from previously coded slices.” When one current slice is encoded, a video encoder will select the best one from the N previously coded slices and signal one index to decoder to initialize the contexts of the current slice from the corresponding context states of the selected previously coded slice (as indicated by the signaled index value).

In some examples, the one or more slices may include a slice that is coded immediately before the current slice.

In some examples, the one or more slices may include a slice that is not coded immediately before the current slice, and the slice meets at least one of following conditions: the slice has a same slice type as the current slice; the slice has a smallest quantization parameter (QP) difference to the current slice; or the slice has a same temporal layer as the current slice.

For example, some implicit selection schemes may be applied to select the corresponding previously coded slice for the context initialization of the current slice according to Rule #1, Rule #2, Rule #3, Rule #4, or any combination of these Rules.

In step 802, the processor 420 may determine initial context states of one or more context models of the current slice by inheriting context states of one or more context models of one slice that is coded prior to the current slice.

By inheriting the context states, the one or more context models of the current slice will use the context states of the one or more context models of one previously coded slice (i.e., the one slice that is coded prior to the current slice) as the initial context states.

In some examples, the one or more initial context states may include at least one of following parameters: a probability value, an adaption rate, or an adaptive weight.

For example, the inherited context states may include different categories of state information, e.g., the probability values, the adaption rates and the combination weights (when the proposed MHP-AW scheme is applied). In one embodiment of the disclosure, it is proposed to only inherit one state information from the selected previously coded slice while the other state information of the current slice is initialized using the existing predefined CABAC initialization tables. In another embodiment, it is proposed to only inherit two state information from the selected previously coded slice. In yet another embodiment, it is proposed to inherit all the state information of the current slice from the corresponding context states of the selected previously coded slice.

In step 803, the processor 420 may encode binary symbols associated with the one or more context models in the current slice according to the initial context states.

In some examples, the processor 420 may determine at least one second initial context state of the current slice according to one or more existing context-based adaptive binary arithmetic coding (CABAC) initialization tables, where the current slice includes the initial context state and the at least one second initial context state. Furthermore, the processor 420 may encode the binary symbols in the current slice according to the initial context states and the at least one second initial context state.

In some examples, there is provided an apparatus for video coding. The apparatus includes a processor 420 and a memory 440 configured to store instructions executable by the processor; where the processor, upon execution of the instructions, is configured to perform any method as illustrated above.

In some other examples, there is provided a non-transitory computer readable storage medium, having instructions stored therein. When the instructions are executed by a processor 420, the instructions cause the processor to perform any method as illustrated in this disclosure. In one example, the plurality of programs may be executed by the processor 420 in the computing environment 410 to receive (for example, from the video encoder 20 in FIG. 2) a bitstream or data stream including encoded video information (for example, video blocks representing encoded video frames, and/or associated one or more syntax elements, etc.), and may also be executed by the processor 420 in the computing environment 410 to perform the decoding method described above according to the received bitstream or data stream. In another example, the plurality of programs may be executed by the processor 420 in the computing environment 410 to perform the encoding method described above to encode video information (for example, video blocks representing video frames, and/or associated one or more syntax elements, etc.) into a bitstream or data stream, and may also be executed by the processor 420 in the computing environment 410 to transmit the bitstream or data stream (for example, to the video decoder 30 in FIG. 3). Alternatively, the non-transitory computer-readable storage medium may have stored therein a bitstream or a data stream including encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

Other examples of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only.

It will be appreciated that the present disclosure is not limited to the exact examples described above and illustrated in the accompanying drawings, and that various modifications and changes can be made without departing from the scope thereof.

What is claimed is:

1. A method for video decoding, comprising:
obtaining, by a binary arithmetic decoder and according to an adaptive weight, a multi-hypothesis probability for a binary symbol of a context model for the binary arithmetic decoder, wherein the multi-hypothesis probability indicates a probability of the binary symbol equaling to a binary value, and the binary symbol is from a plurality of binary symbols associated with the context model; and
decoding, by the binary arithmetic decoder, the binary symbol according to the multi-hypothesis probability.

2. The method of claim 1, further comprising:
obtaining, by the binary arithmetic decoder, a first probability for the binary symbol according to a first adaptation parameter;
obtaining, by the binary arithmetic decoder, a second probability for the binary symbol according to a second adaption parameter; and
obtaining, by the binary arithmetic decoder, the multi-hypothesis probability according to the adaptive weight, the first probability, and the second probability.

3. The method of claim 1, further comprising:
obtaining, by the binary arithmetic decoder, the adaptive weight according to the context model from a set of predetermined integer weight values in a weight initialization table.

4. The method of claim 1, further comprising:
obtaining, by the binary arithmetic decoder, a weight initialization table for each slice type; and
in response to determining that a current slice is a first slice type, selecting, by the binary arithmetic decoder, the weight initialization table according to the first slice type, wherein the first slice type comprises an I type, a P type, or a B type; and
obtaining, by the binary arithmetic decoder, the adaptive weight according to the weight initialization table that is selected.

5. The method of claim 4, further comprising:
obtaining, by the binary arithmetic decoder, a control syntax element in a picture parameter set (PPS) indicating whether to select the weight initialization table for each slice.

6. The method of claim 5, further comprising:
in response to determining that the control syntax element is enabled, obtaining, by the binary arithmetic decoder and at a slice level, an adaptive weight syntax element for each slice indicating the weight initialization table selected for each slice according to a slice type of each slice.

7. The method of claim 1, further comprising:
obtaining, by the binary arithmetic decoder, a first weight initialization table for each I slice, a second weight initialization table for each P slice, and a third weight initialization table for each B slice;
in response to determining that a current slice is an I slice, selecting, by the binary arithmetic decoder, the first weight initialization table;
in response to determining that the current slice is a P slice or a B slice, selecting, by the binary arithmetic decoder, the second weight initialization table or the third weight initialization table; and
obtaining, by the binary arithmetic decoder, the adaptive weight according to a selected weight initialization table.

8. The method of claim 7, further comprising:
in response to determining that the current slice is not an I slice, obtaining, by the binary arithmetic decoder, a control syntax element in a picture parameter set (PPS) indicating whether to select a weight initialization table for each slice; and
in response to determining that the control syntax element is enabled, obtaining, by the binary arithmetic decoder, at a slice level, an adaptive weight syntax element for each non-I slice indicating a weight initialization table that is selected from the second weight initialization table and the third weight initialization table.

9. An apparatus for video decoding, comprising:
one or more processors; and
a memory coupled to the one or more processors and configured to store instructions executable by the one or more processors,
wherein the one or more processors, upon execution of the instructions, are configured to perform operations comprising:
obtaining, according to an adaptive weight, a multi-hypothesis probability for a binary symbol of a context model, wherein the multi-hypothesis probability indicates a probability of the binary symbol equaling to a binary value, and the binary symbol is from a plurality of binary symbols associated with the context model; and
decoding the binary symbol according to the multi-hypothesis probability.

10. The apparatus for video decoding of claim 9, wherein the operations further comprise:
obtaining a first probability for the binary symbol according to a first adaptation parameter;
obtaining a second probability for the binary symbol according to a second adaption parameter; and
obtaining the multi-hypothesis probability according to the adaptive weight, the first probability, and the second probability.

11. The apparatus for video decoding of claim 9, wherein the operations further comprise:
obtaining the adaptive weight according to the context model from a set of predetermined integer weight values in a weight initialization table.

12. The apparatus for video decoding of claim 9, wherein the operations further comprise:
obtaining a weight initialization table for each slice type; and
in response to determining that a current slice is a first slice type, selecting the weight initialization table according to the first slice type, wherein the first slice type comprises an I type, a P type, or a B type; and
obtaining the adaptive weight according to the weight initialization table that is selected.

13. The apparatus for video decoding of claim 12, wherein the operations further comprise:
obtaining a control syntax element in a picture parameter set (PPS) indicating whether to select a weight initialization table for each slice.

14. The apparatus for video decoding of claim 13, wherein the operations further comprise:
in response to determining that the control syntax element is enabled, obtaining, at a slice level, an adaptive weight syntax element for each slice indicating a weight initialization table selected for each slice according to a slice type of each slice.

15. The apparatus for video decoding of claim 9, wherein the operations further comprise:
obtaining a first weight initialization table for each I slice, a second weight initialization table for each P slice, and a third weight initialization table for each B slice;
in response to determining that a current slice is an I slice, selecting the first weight initialization table;
in response to determining that the current slice is a P slice or a B slice, selecting the second weight initialization table or the third weight initialization table; and
obtaining the adaptive weight according to a selected weight initialization table.

16. The apparatus for video decoding of claim 15, wherein the operations further comprise:
in response to determining that the current slice is not an I slice, obtaining a control syntax element in a picture parameter set (PPS) indicating whether to select a weight initialization table for each slice; and
in response to determining that the control syntax element is enabled, obtaining, at a slice level, an adaptive weight syntax element for each non-I slice indicating a weight initialization table that is selected from the second weight initialization table and the third weight initialization table.

17. A non-transitory computer-readable storage medium storing a bitstream to be decoded by a decoding method, the decoding method comprising:
obtaining, by a binary arithmetic decoder and according to an adaptive weight, a multi-hypothesis probability for a binary symbol of a context model for the binary arithmetic decoder, wherein the multi-hypothesis probability indicates a probability of the binary symbol equaling to a binary value, and the binary symbol is from a plurality of binary symbols associated with the context model; and
decoding, by the binary arithmetic decoder, the binary symbol according to the multi-hypothesis probability.

18. The non-transitory computer-readable storage medium of claim 17, wherein the decoding method further comprises:
obtaining, by the binary arithmetic decoder, a first probability for the binary symbol according to a first adaptation parameter;
obtaining, by the binary arithmetic decoder, a second probability for the binary symbol according to a second adaption parameter; and
obtaining, by the binary arithmetic decoder, the multi-hypothesis probability according to the adaptive weight, the first probability, and the second probability.

19. The non-transitory computer-readable storage medium of claim 17, wherein the decoding method further comprises:
obtaining, by the binary arithmetic decoder, the adaptive weight according to the context model from a set of predetermined integer weight values in a weight initialization table.

20. The non-transitory computer-readable storage medium of claim 17, wherein the decoding method further comprises:
obtaining, by the binary arithmetic decoder, a weight initialization table for each slice type; and
in response to determining that a current slice is a first slice type, selecting, by the binary arithmetic decoder, the weight initialization table according to the first slice type, wherein the first slice type comprises an I type, a P type, or a B type; and
obtaining, by the binary arithmetic decoder, the adaptive weight according to the weight initialization table that is selected.
